(19) United States
(12) Patent Application Publication
(10) Pub. No.: US 2002/0008669 A1
(43) Pub. Date: Jan. 24, 2002

(54) REFLECTIVE ANTENNA SYSTEM WITH INCREASED FOCAL LENGTH

(76) Inventors: NICHOLAS L. MUHLHAUSER, LOS GATOS, CA (US); KENNETH P. CANNIZZARO, LOS GATOS, CA (US); BRIAN C. HEWETT, LOS ALTOS, CA (US)

Correspondence Address: MATTHEW W STAVISH ESQ, LINIAK BERENATO LONGACRE & WHITE, 6550 ROCK SPRING DRIVE, SUITE 240, BETHESDA, MD, 20817, US

(21) Appl. No.: 09/438,322

(22) Filed: Nov. 12, 1999

(51) Int. Cl. H01Q 13/00; H01Q 19/12

(52) U.S. Cl. 343/840; 343/781 R

(57) ABSTRACT

A multiple beam antenna system including an offset parabolic reflector has an increased focal length (FL) and/or an increased FL/D (where D is a diameter of the reflector) in order to improve off-axis performance of the system. In certain embodiments, the system can simultaneously receive different signals from different satellites that are orbitally spaced.

This invention relates to a reflector based multiple beam antenna system including an increased focal length that improves off-axis performance. In certain embodiments, this invention relates to a multiple beam antenna system for receiving microwaves from multiple satellites simultaneously from geostationary satellites.

### BACKGROUND OF THE INVENTION

High gain antennas are widely useful for communication purposes such as radar, television receive-only (TVRO) earth station terminals, and other conventional sensing/transmitting uses. In general, high antenna gain is associated with high directivity, which in turn arises from a large radiating aperture.

Conventional 18 inch (i.e. 18 inch diameter or 18 inches wide) offset parabolic reflective antenna systems suffer significant losses in off-axis performance. Such a DBS type single satellite conventional system is shown in FIG. 1, and includes mount assembly 1, reflector 3, azimuthal adjustment mechanism 5, elevational adjustment mechanism 7, boom 9, and LNBF 11. This conventional reflector antenna system has a focal length FL of approximately 10.625 inches. Length L between focal point 13 and the top of the reflector may be about 18.25 inches. Thus, the antenna system has a FL/D (i.e. focal length FL divided by diameter D) of about 0.6.

Unfortunately, the 18 inch (projected diameter) direct broadcast satellite (DBS) offset parabolic antenna or dish system of FIG. 1 suffers significant losses in off-axis performance. For example, when comparing the relative gain of 0 degrees on-axis with 5 degrees off-axis, a slight performance degradation of 0.35 dB is observed. This becomes much worse when observing 10 and 15 degree off-axis angle performance with 1.5 dB and 4.2 dB loss respectively. This rapid performance degradation beyond a 5 degree scan angle is more than most DBS systems can tolerate under most circumstances. DBS satellites have a 9 degree orbital spacing, requiring a system of 0 degrees on-axis and both +10 and −10 degrees off-axis capability to be able to satisfactorily view all three of these DBS orbital locations.

It is apparent from the above that there exists a need in the art for a multiple beam antenna system (e.g. of the TVRO or DBS type) which is small in size, cost effective, and able to increase the off axis antenna gain without significantly increasing the reflector size. There also exists a need for such a multiple beam antenna system with improved off-axis performance, wherein the improved off-axis performance enables the use of a simple parabolic reflector for multiple beams to view multiple satellites simultaneously.

It is a purpose of this invention to fulfill any or all of the above-described needs in the art, as well as other needs apparent to the skilled artisan from the following detailed description of this invention.

### SUMMARY OF THE INVENTION

An object of this invention is to provide a multiple beam antenna system with improved off-axis performance, wherein the improved off-axis performance enables the use of a similar sized simple parabolic reflector for multiple beams to view multiple satellites simultaneously.

Another object of this invention is to provide an antenna system that when steered off axis maintains at off axis viewing angles (e.g. from about plus/minus 1-15 degrees off axis) suitable reception of DBS entertainment television signals.

Another object of this invention is to adjust the focal length FL or focal length/diameter (FL/D) of a parabolic reflective antenna for the purpose of improving off axis performance.

Another object of this invention is to provide a multi-beam parabolic reflector antenna system capable of steering off-axis plus/minus ten degrees with a loss of no greater than about 1.5 dB, more preferably less than about 1.0 dB, even more preferably less than about 0.75 dB, and most preferably less than about 0.5 dB. In certain embodiments, this invention will have 10 degree off axis performance in either direction at least as good as the on-axis performance of certain conventional parabolic antenna systems.

Another object of this invention is to provide an offset parabolic antenna system having an FL/D of at least about 0.7 in order to improve off-axis performance.

In certain embodiments of this invention, the reflector is parabolic shaped; while in other embodiments the reflector may be non-parabolic shaped or have non-parabolic components.

Another object of this invention is to provide users having more than one satellite with a single reflector based antenna system that can simultaneously receive multiple orbitally spaced satellite signals from different satellites (e.g. about 9 degrees apart) with 10 9-10 degree off-axis performance in either direction at least as good as on-axis performance of certain conventional offset parabolic systems.

Another object of this invention is to provide an offset parabolic antenna system, including a parabolic reflector having a diameter of about 19 inches or less, having a gain of at least about 33.6 dBi from about −10 degrees off axis to +10 degrees off axis. In certain embodiments, gain may be increased by increasing diameter and gain may be decreased by decreasing diameter.

Another object of this invention is to provide an offset parabolic antenna system having an FL/D of at least about 0.7, and having a gain of at least about 33.6 dBi when steered off axis through a range of from about −10 degrees off axis to +10 degrees off axis.

In certain embodiments, there may be from one to three or more feedhorns depending upon the number of satellites desired to view or receive signals from.

In certain optional embodiments, an adaptive dielectric lens may be used to accommodate a conventional LNBF for use with larger FL/D reflector systems.

In other optional embodiments, an LNBF feed horn aperture may be increased so that the LNBF may be relocated to multiple on and off-axis positions while enabling the feed horn to properly illuminate the longer FL/D reflector.

In other optional embodiments, an integrated multiple input (multi-satellite) LNBF that utilizes common components may be used.

Another object of this invention is to provide a multibeam antenna system in which an optimal FL and minimum parabolic reflector size provide acceptable performance when receiving off axis signals from multiple satellites.

Another object of this invention is to provide a multibeam antenna using a parabolic reflector with a standard or retrofitted LNBF horn that illuminates the chosen FL/D reflector.

Another object of this invention is to provide a multibeam antenna system with parabolic reflector having at least one lens retrofitted onto a conventional LNBF horn for illuminating the chosen FL/D reflector.

Yet another object of this invention is to provide a multibeam parabolic antenna system which may be configured by choosing a FL/D to meet various satellite EIRP requirements when receiving off-axis signals from multiple satellites.

Another object of this invention is to fulfill any and/or all of the above listed objects or needs.

Generally speaking, this invention fulfills any or all of the above described needs and/or objects by providing a multiple beam antenna system for simultaneously receiving signals at different orbital spacing from different satellites, the system comprising:

an offset parabolic reflector, having a focal length (FL) of at least about 14 inches; and

said parabolic reflector being dimensioned so as to have an FL/D of at least about 0.7, where D is a diameter of said reflector, so that said system has a gain loss of no more than about 1.5 dB relative to its on-axis gain when steered to off-axis viewing angles of from about +10 degrees to −10 degrees off axis.

In still further embodiments of this invention, any or all of the above listed needs or objects may be fulfilled by providing a method of improving off-axis performance of an offset parabolic antenna system, comprising the steps of:

selecting a focal length (FL) and diameter (D) of a parabolic reflector so that FL/D is at least about 0.7 in order to improve off-axis performance; and

receiving a first satellite signal on axis and a second satellite signal from about 8-10 degrees off axis in a manner such that the system experiences a gain loss of no more than about 1.5 dB when receiving the off axis signal relative to the on axis signal.

Those skilled in the art will appreciate the fact that antennas herein are reciprocal transducers which exhibit similar properties in both transmission and reception modes. For example, the antenna patterns for both transmission and reception are identical and exhibit approximately the same gain. For convenience of explanation, descriptions are often made in terms of either transmission or reception of signals, with the other operation being understood. Thus, it is to be understood that the antenna systems of the different embodiments of this invention to be described below may pertain to either a transmission or reception mode of operation. Those skilled in the art will also appreciate the fact that the frequencies received/transmitted may be varied up or down in accordance with the intended application of the system.

This invention will now be described with respect to certain embodiments thereof, accompanied by certain illustrations, wherein:

### IN THE DRAWINGS

FIG. 1 is a side elevation view of a conventional parabolic reflector based antenna system.

FIG. 2 is a side elevation view of a parabolic reflector based antenna system having an increased focal length (FL) according to an embodiment of this invention.

FIG. 3 is a schematic diagram of the antenna system of FIG. 2, illustrating certain dimensions thereof.

FIG. 4 is a frontal schematic view of the reflector of the FIG. 2 antenna system.

FIG. 5 is a computed single reflector antenna scan loss at 10 degrees off axis graph at 12.45 GHz, 10 dB edge illumination, 0.5 inch offset, of different reflectors having diameters from 17-21 inches according to different embodiments of this invention; the axes of this graph being focal length versus scan loss (dB), where scan loss in dB is referenced to the on axis gain of a conventional 18 inch reflector with an FL/D of 0.6 as shown in FIG. 1.

FIG. 6 is a computed single reflector antenna scan loss at 11 degrees off axis graph at 12.45 GHz, 10 dB edge illumination, 0.5 inch offset, of different reflectors having diameters from 17-21 inches according to different embodiments of this invention; the axes of this graph being focal length versus scan loss (dB), where scan loss in dB is referenced to the on axis gain of a conventional 18 inch reflector with an FL/D of 0.6 as shown in FIG. 1.

FIG. 7 is a computed single reflector antenna scan loss at 12 degrees off axis graph at 12.45 GHz, 10 dB edge illumination, 0.5 inch offset, of different reflectors having diameters from 17-21 inches according to different embodiments of this invention; the axes of this graph being focal length versus scan loss (dB), where scan loss in dB is referenced to the on axis gain of a conventional 18 inch reflector with an FL/D of 0.6 as shown in FIG. 1.

FIG. 8 is a computed single reflector antenna scan loss at 13.3 degrees off axis graph at 12.45 GHz, 10 dB edge illumination, 0.0 cm offset, of different reflectors having diameters from 65-80 cm according to different embodiments of this invention; the axes of this graph being focal length versus scan loss (dB), where scan loss in dB is referenced to the on axis gain of a conventional 70 cm diameter reflector with an FL/D of 0.6.

FIG. 9 is a computed single reflector antenna scan loss at 15 degrees off axis graph at 12.45 GHz, 10 dB edge illumination, 0.5 inch offset, of different reflectors having diameters from 17-21 inches according to different embodiments of this invention; the axes of this graph being focal length versus scan loss (dB), where scan loss in dB is referenced to the on axis gain of a conventional 18 inch reflector with a FL/D of 0.6 as shown in FIG. 1.

FIG. 10 is a side partial cross sectional and partial elevation view of an adaptive lens mounted in a bracket or housing that attaches and locates the lens in a correct manner to the feed of a conventional LNBF, according to an optional embodiment of this invention.

FIG. 11(a) is an elevation view of an optional aluminum horn extension according to an embodiment of this invention.

FIG. 11(b) is a side cross sectional view of the extension of FIG. 11(a).

FIG. 12(a) is an elevational view of another optional aluminum horn extension that may be used in another embodiment of this invention.

FIG. 12(b) is a side cross sectional view of the extension of FIG. 12(a).

FIG. 13 is a side cross sectional view of the extension of FIG. 12 on a horn according to an embodiment of this invention.

FIG. 14 is a perspective view of a parabolic reflector based antenna system having an increased focal length (FL) and monoblock of LNBFs according to another embodiment of this invention.

FIG. 15 is another perspective view of the antenna system of FIG. 14.

FIG. 16 is a viewing angle (degrees) versus gain magnitude (dB) graph comparing (i) an antenna system according to an embodiment of this invention having a 15 inch FL, and 19 inch diameter, to (ii) a conventional 18 inch Echostar DISH offset parabolic antenna having a FL or about 10.6 inches, at 12.20 GHz; wherein the antenna system according to this invention is shown on axis as well as plus and minus 10 degrees off axis, while the Echostar system is shown on axis.

FIG. 17 is a viewing angle (degrees) versus gain magnitude (dB) graph comparing (i) an antenna system according to an embodiment of this invention having a 15 inch FL, and 19 inch diameter, to (ii) a conventional 18 inch Echostar DISH offset parabolic antenna having a FL or about 10.6 inches, at 12.45 GHz; wherein the antenna system according to this invention is shown on axis as well as plus and minus 10 degrees off axis, while the Echostar system is shown on axis.

FIG. 18 is a viewing angle (degrees) versus gain magnitude (dB) graph comparing (i) an antenna system according to an embodiment of this invention having a 15 inch FL, and 19 inch diameter, to (ii) a conventional 18 inch Echostar DISH offset parabolic antenna having a FL or about 10.6 inches, at 12.70 GHz; wherein the antenna system according to this invention is shown on axis as well as plus and minus 10 degrees off axis, while the Echostar system is shown on axis.

FIG. 19 is a viewing angle (degrees) versus gain magnitude (dB) graph of an antenna system according to an embodiment of this invention, showing on axis performance and off axis performance at plus/minus 10 degrees off axis.

FIG. 20 is an amplitude (dB) versus 29-25 Log (viewing angle) graph of an offset parabolic reflector based DBS antenna system's performance at 12.45 Ghz, azimuthal RHCP co-pol on axis without cover, the system having a FL of 0.789 and a D of 19 inches, according to an embodiment of this invention taken on the Comsat range in Gaithersburg, Md.

FIG. 21 is an amplitude (dB) versus 29-25 Log (viewing angle) graph of an offset parabolic reflector based DBS antenna system's performance at 12.45 Ghz, elongated RHCP co-pol on axis without cover, the system having a FL of 0.789 and a D of 19 inches, according to an embodiment of this invention taken on the Comsat range in Gaithersburg, Md. (this system being the same antenna system as tested in FIG(S). 20).

FIG. 22 is an amplitude (dB) versus 29-25 Log (viewing angle) graph of an offset parabolic reflector based DBS antenna system's performance at 12.45 Ghz, azimuthal RHCP cross-pol on axis without cover, the system having a FL of 0.789 and a D of 19 inches, according to an embodiment of this invention taken on the Comsat range in Gaithersburg, Md. (this system being the same antenna system as tested in FIG(S). 20-21).

FIG. 23 is an amplitude (dB) versus 29-25 Log (viewing angle) graph of an offset parabolic reflector based DBS antenna system's performance at 12.45 Ghz, elongated RHCP cross-pol on axis without cover, the system having a FL of 0.789 and a D of 19 inches, according to an embodiment of this invention taken on the Comsat range in Gaithersburg, Md. (this system being the same antenna system as tested in FIG(S). 20-22).

FIG. 24 is an amplitude (dB) versus 29-25 Log (viewing angle) graph of an offset parabolic reflector based DBS antenna system's performance at 12.45 Ghz, azimuthal RHCP co-pol −10 degrees off axis without cover, the system having a FL of 0.789 and a D of 19 inches, according to an embodiment of this invention taken on the Comsat range in Gaithersburg, Md. (this system being the same antenna system as tested in FIG(S). 20-23).

FIG. 25 is an amplitude (dB) versus 29-25 Log (viewing angle) graph of an offset parabolic reflector based DBS antenna system's performance at 12.45 Ghz, elongated RHCP co-pol −10 degrees off axis without cover, the system having a FL of 0.789 and a D of 19 inches, according to an embodiment of this invention taken on the Comsat range in Gaithersburg, Md. (this system being the same antenna system as tested in FIG(S). 20-24).

FIG. 26 is an amplitude (dB) versus 29-25 Log (viewing angle) graph of an offset parabolic reflector based DBS antenna system's performance at 12.45 Ghz, azimuthal RHCP cross-pol −10 degrees off axis without cover, the system having a FL of 0.789 and a D of 19 inches, according to an embodiment of this invention taken on the Comsat range in Gaithersburg, Md. (this system being the same antenna system as tested in FIG(S). 20-25).

FIG. 27 is an amplitude (dB) versus 29-25 Log (viewing angle) graph of an offset parabolic reflector based DBS antenna system's performance at 12.45 Ghz, elongated RHCP cross-pol −10 degrees off axis without cover, the system having a FL of 0.789 and a D of 19 inches, according to an embodiment of this invention taken on the Comsat range in Gaithersburg, Md. (this system being the same antenna system as tested in FIG(S). 20-26).

FIG. 28 is an amplitude (dB) versus 29-25 Log (viewing angle) graph of an offset parabolic reflector based DBS antenna system's performance at 12.45 Ghz, azimuthal RHCP co-pol +10 degrees off axis without cover, the system having a FL of 0.789 and a D of 19 inches, according to an embodiment of this invention taken on the Comsat range in Gaithersburg, Md. (this system being the same antenna system as tested in FIG(S) 20-27).

FIG. 29 is an amplitude (dB) versus 29-25 Log (viewing angle) graph of an offset parabolic reflector based DBS antenna system's performance at 12.45 Ghz, elongated RHCP co-pol +10 degrees off axis without cover, the system having a FL of 0.789 and a D of 19 inches, according to an embodiment of this invention taken on the Comsat range in Gaithersburg, Md. (this system being the same antenna system as tested in FIG(S). 20-28).

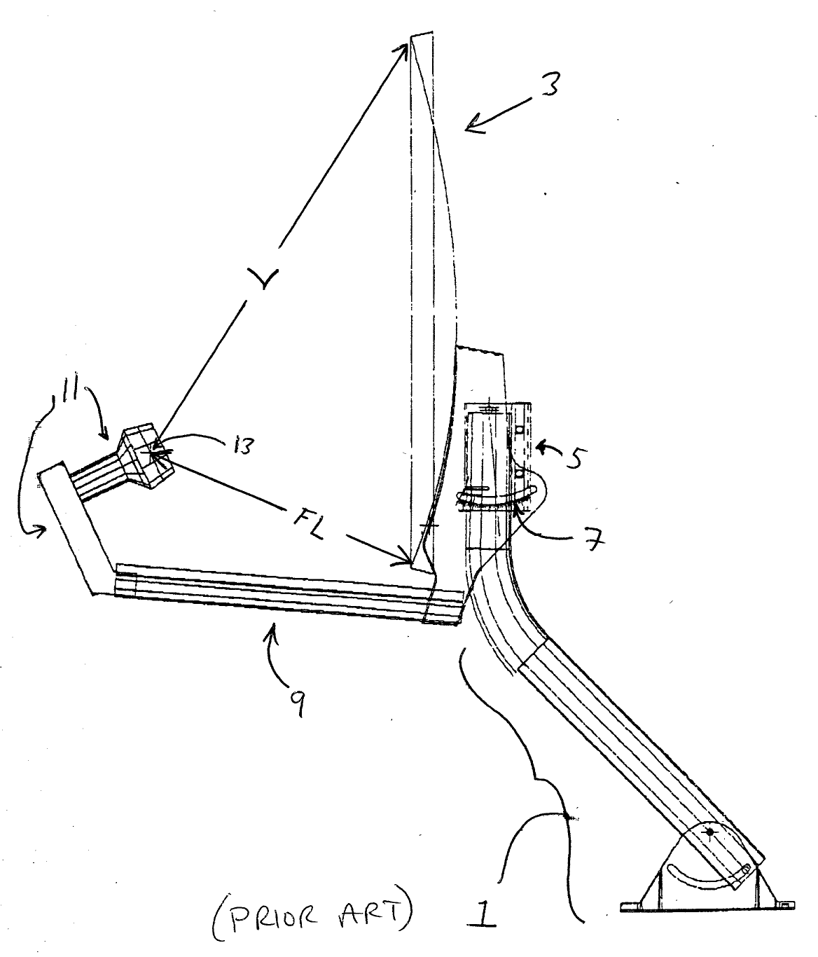

### DETAILED DESCRIPTION OF CERTAIN EMBODIMENTS OF THIS INVENTION

Referring now more particularly to the accompanying drawings in which like reference numerals indicate like parts throughout the several views.

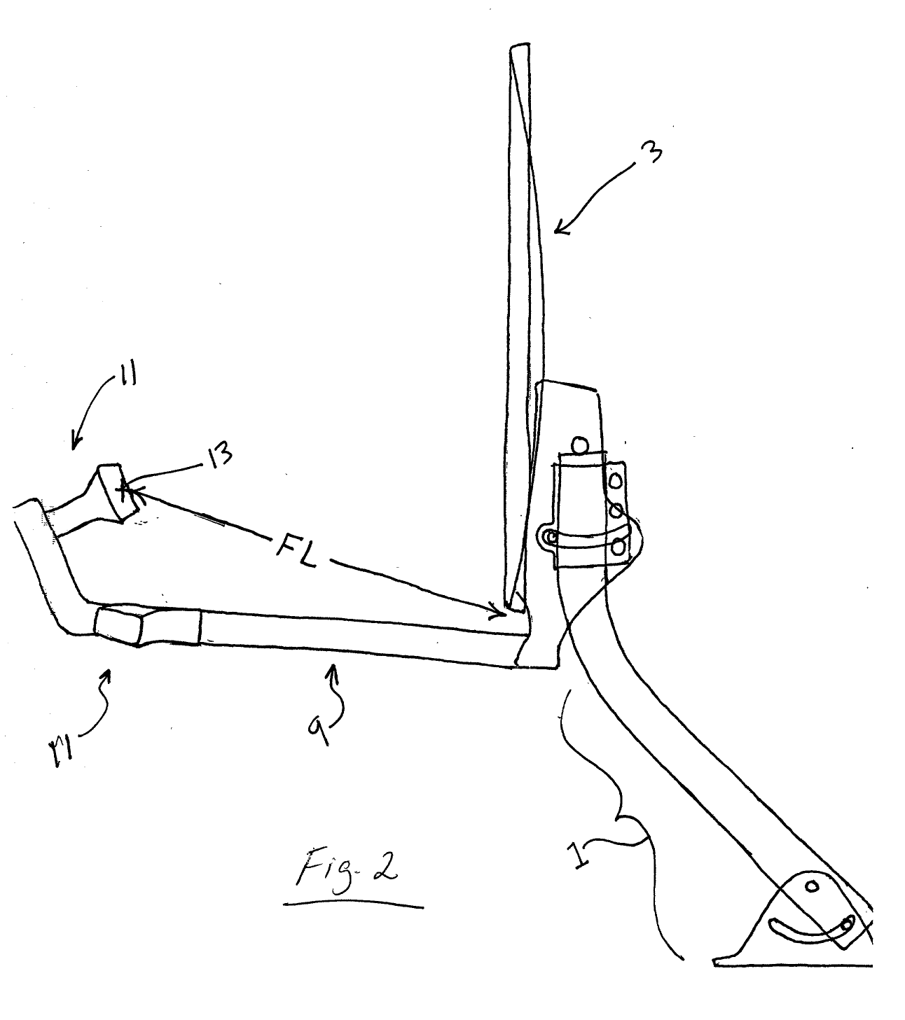

FIG. 2 is a side elevation view of a multiple beam offset parabolic reflector based DBS antenna system according to an embodiment of this invention, the system including mount assembly 1, reflector 3, boom 9, from one to three LNBFs and feedhorns 11, and parabolic focal point 13. Reflector 3 is preferably parabolic in all directions, but alternatively may be parabolic in only the horizontal direction in certain embodiments and may be non-parabolic in other embodiments. In certain preferred embodiments, reflector 3 may be made of structural foam including a reflective metallic coating thereon. In other embodiments, the reflector and the rest of the antenna system may be made using conventional sheet metal technology. Mount assembly 1 supports reflector 3 and enables elevational adjustment, azimuthal adjustment, and/or rotational adjustment of the reflector and feedhorn(s) about the Clark belt. The positions of the feedhorn(s) dictate which satellite(s) are to be used; it is noted that there for example may be a 9 degree difference in the location of the satellite corresponding to adjacent feedhorns. Thus, in certain embodiments three different feedhorns may be used for a corresponding three different satellites to be simultaneously or otherwise viewed. In other embodiments, a single feedhorn may be used. The antenna system has a focal length FL, and the reflector 3 has a diameter D (measured in the dimension in/out of the page as shown in FIG. 2). The antenna system is capable of simultaneously receiving (and transmitting) multiple beams from a plurality of different satellites (e.g. three 9 degree spaced geostationary satellites) without significant gain loss.

In certain embodiments, the antenna system can receive linear components of circularly polarized signals from satellites, process them, and recreate them to enable a viewer to utilize the received circularly polarized signals. The system is adapted to receive signals in about the 10.70-12.75 GHz range in certain embodiments.

The multiple beam antenna systems of the different embodiments may be used in association with, for example, DBS and TVRO applications. In such cases, an antenna system of relatively high directivity is provided and designed for a limited field of view. The system when used in at least DBS applications provides sufficient G/T to adequately demodulate digital or analog television downlink signals from high and/or medium powered Ku band DBS and FSS satellites in geostationary orbit. Other frequency bands may also be transmitted/received.

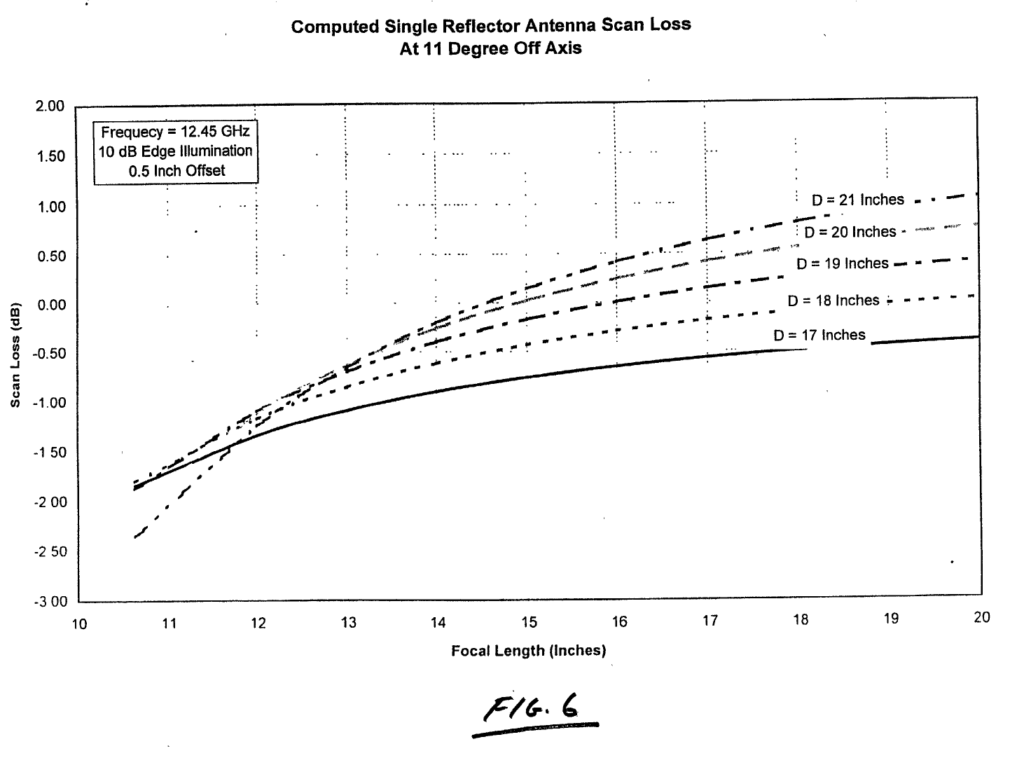

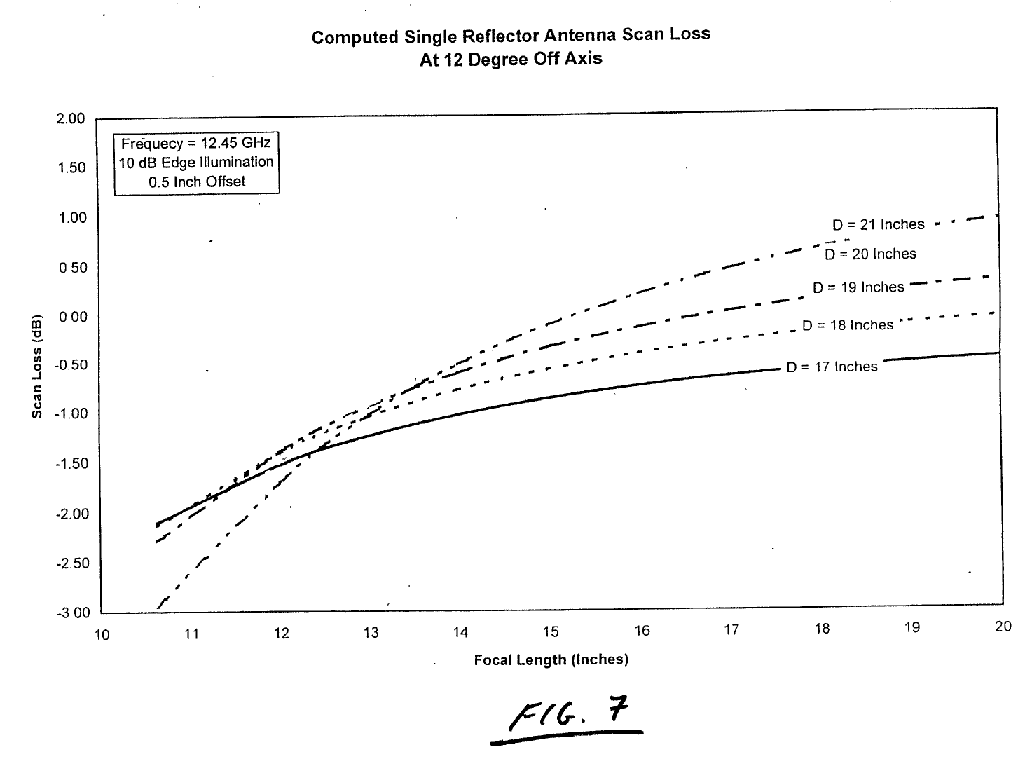

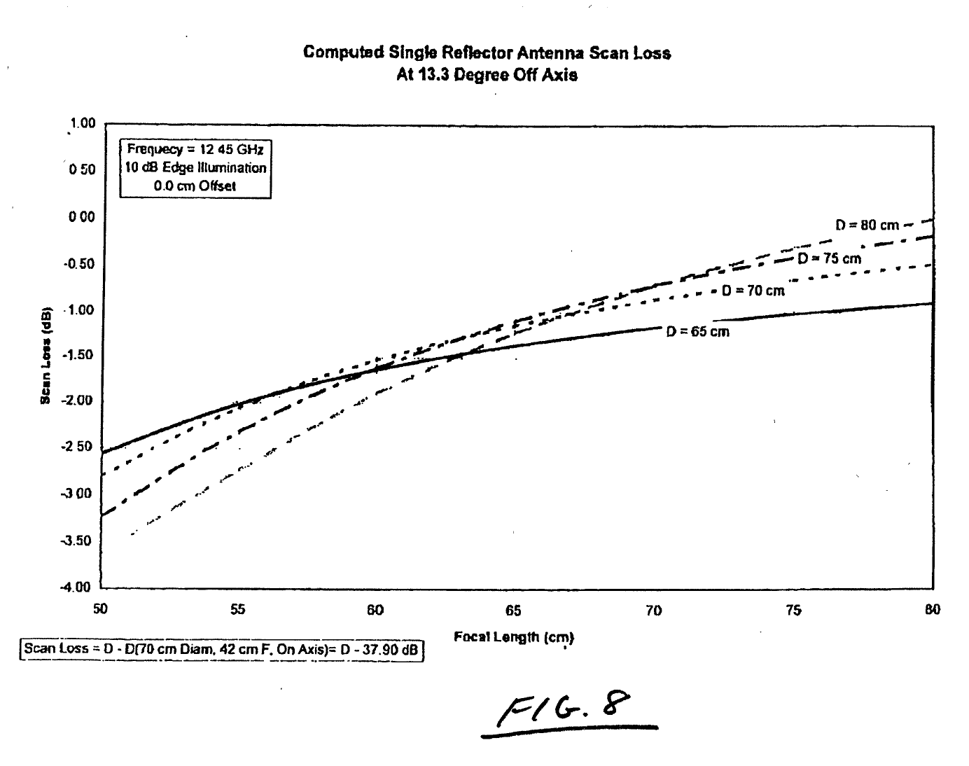

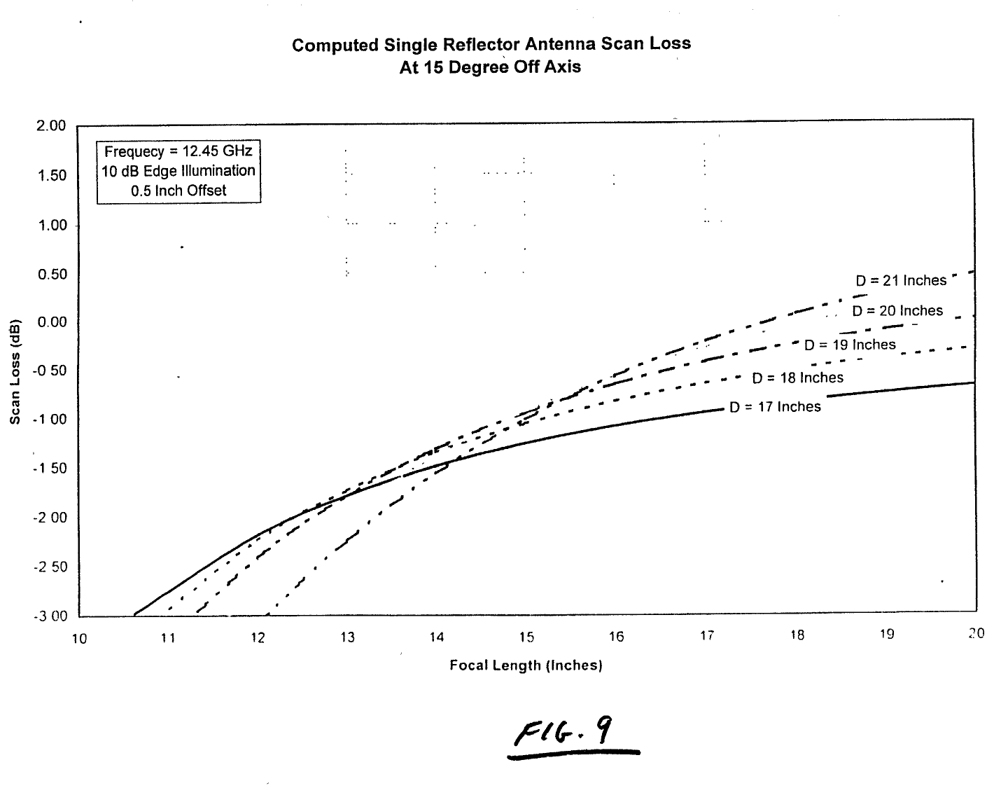

According to certain embodiments of this invention, the focal length FL and/or the characteristic FL/D (i.e. focal length divided by diameter) is/are increased in order to improve off-axis performance. The improved off axis performance may enable the use of a single parabolic reflector for simultaneously receiving multiple beams from different satellites. FIGS. 5-9 compares at 12.45 GHz performance of different reflector 3 sizes (e.g. diameters D of from 17 to 21 inches) at different focal lengths (i.e. FLs from 10 to 20 inches), at different off axis viewing angles (i.e. from 10-15 degrees off axis). The illustrated “scan loss” is relative to the on-axis performance of a conventional 18 inch diameter offset parabolic having a FL/D of 0.6 and a focal length of about 10.625 inches. These graphs illustrate that, at off-axis viewing angles of from 0-10 degrees, and even from 0-15 degrees off axis, there are a number of embodiments herein that can achieve performance at least about as good as conventional 18 inch dish on-axis performance. For example, an offset parabolic reflector 3 according to an embodiment of this invention having a 19 inch diameter (D=19 inches) and a focal length (FL) of 15 inches is one solution. As illustrated, other FLs and/or Ds may also be used to enhance off-axis performance for various EIRP requirements. An antenna with enhanced off-axis performance may be used in alternative embodiments for other satellite systems as in FSS (on 2 degree spacing), both Ku and Ka as well as terrestrial microwave systems.

In preferred embodiments of this invention, FL is increased relative to conventional systems. FL is preferably at least about 14 inches, even more preferably at least about 15 inches. FL may be from about 14 to 32 inches. Moreover, FL/D is also increased relative to conventional systems in order to improve off-axis performance. FL/D is preferably at least about 0.7 in certain embodiments, more preferably at least about 0.75. In an embodiment where FL is 15 inches and D is 19 inches, FL would be 0.789. These increases enable off-axis performance to be improved.

According to one specific example, the system enables reception from 101 degrees, 110 degrees, and 119 degrees simultaneously using the same reflector 3 and three LNBFs and/or feedhorns.

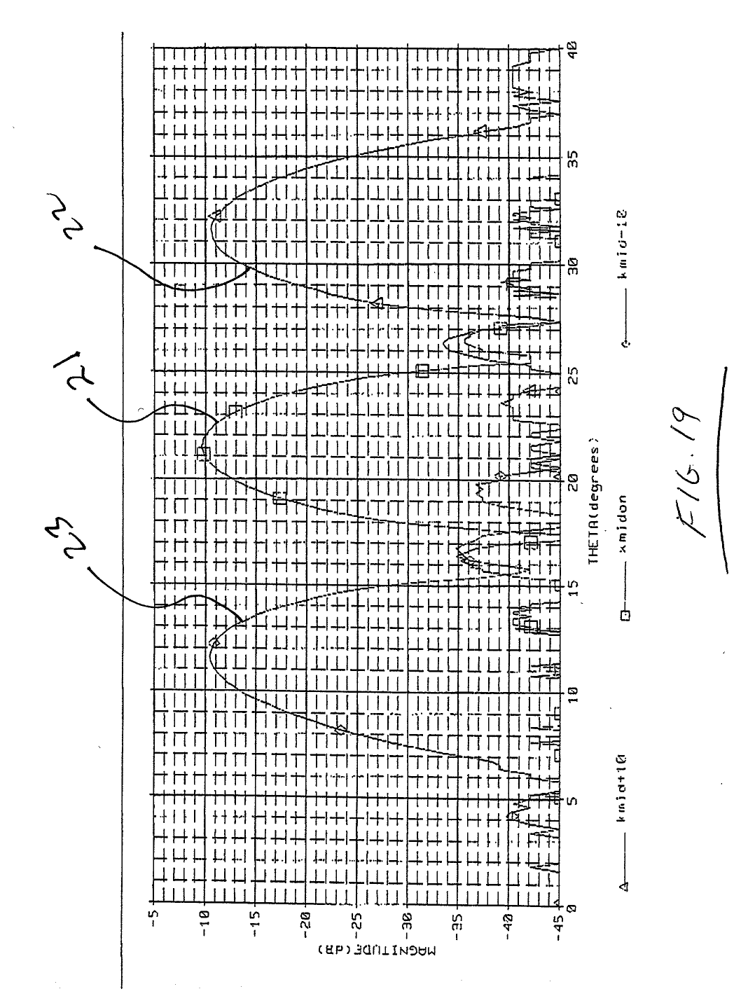

As shown in FIGS. 16-18, antenna systems according to certain embodiments of this invention have IRD signal strengths and/or gain performance at plus/minus 10 degrees off axis which are at least as good as on axis performance of a conventional Echostar 18 inch DISH. Systems according to certain embodiments of this invention also have half power beam widths lower than the Echostar 18 inch DISH having a FL/D of about 0.6 over this range of angles, and comply with FCC side lobe specification 25.209 (incorporated herein by reference) for any scan angle from minus 10 through plus 10 degrees off axis.

For example, FIG. 16 compares performance at 12.20 GHz of (i) a multibeam offset parabolic antenna system of this invention having a FL of 15.0 inches, a D of 19 inches and a FL/D of 0.789, with (ii) a conventional Echostar offset parabolic DISH with a FL of about 10.6 inches, a D of 18 inches, and a FL/D of about 0.6. Curve 21 illustrates on-axis performance of the a multibeam offset parabolic antenna system of this invention having a FL of 15.0 inches, curve 22 illustrating its performance at +10 degrees off axis, and curve 23 illustrating its performance at −10 degrees off axis. Curve 24 illustrates the Echostar 18 inch parabolic antenna, having an FL/D of about 0.6, on axis, having a typical gain of about 33.6 dBi. As shown, curve 21 has a relative gain of about 1.2 dB greater than conventional Echostar on axis curve 24, giving curve 21 a gain of about 34.8 dBi; while the antenna according to this invention has a gain −10 degrees off axis of about 0.5 dB (see curve 23) greater than conventional Echostar on axis curve 24, and a gain +10 degrees off axis of about 0.5 dB greater than conventional Echostar on axis curve 24 (see curve 22). These gains are all better than the Echostar antenna on axis gain (see curve 24). This illustrates that in certain embodiments of this invention, antenna systems of this invention perform better off axis (e.g. at plus/minus 10 degrees off axis) than a conventional system does on axis. Note the small gain rolloff (i.e. deterioration of performance) of the system of this invention at plus/minus 10 degrees relative to its on axis performance.

In certain embodiments of this invention, gain loss at plus/minus 10 degrees off axis compared to on axis is no greater than about 1.5 dB, more preferably no greater than about 1.0 dB, even more preferably no greater than about 0.75 dB, and most preferably no greater than about 0.5 dB. In certain embodiments of this invention, antennas have an on-axis gain of at least about 34.0 dBi, more preferably of at least about 34.5 dBi, and most preferably of at least about 35 dBi.

As for FIG. 17, it compares performance at 12.45 GHz of (i) a multibeam offset parabolic antenna system of this invention having a FL of 15.0 inches, a D of 19 inches and a FL/D of 0.789, with (ii) a conventional Echostar offset parabolic DISH with a FL of about 10.6 inches, a D of 18 inches, and a FL/D of about 0.6. Curve 21 illustrates on-axis performance of the a multibeam offset parabolic antenna system of this invention having a FL of 15.0 inches, curve 22 illustrating its performance at +10 degrees off axis, and curve 23 illustrating its performance at −10 degrees off axis. Curve 24 illustrates the Echostar 18 inch parabolic antenna, having an FL/D of about 0.6, on axis, having a typical gain of about 33.6 dBi. As shown, curve 21 has a relative gain of about 1.3 dB greater than conventional Echostar on axis curve 24, giving curve 21 a gain of about 34.9 dBi; while the antenna according to this invention has a gain −10 degrees off axis of about 0.6 dB (see curve 23) greater than conventional Echostar on axis curve 24 (for a gain of about 34.2 dBi), and a gain +10 degrees off axis of about 0.4 dB greater than conventional Echostar on axis curve 24 (see curve 22), for a gain of about 34.0 dBi. These gains of 21-23 are all better than the Echostar antenna on axis gain of curve 24. This illustrates that in certain embodiments of this invention, antenna systems of this invention perform better off axis (e.g. at plus/minus 10 degrees off axis) than a conventional system does on axis. Note the small gain rolloff (i.e. deterioration of performance) of the system of this invention at plus/minus 10 degrees relative to its on axis performance.

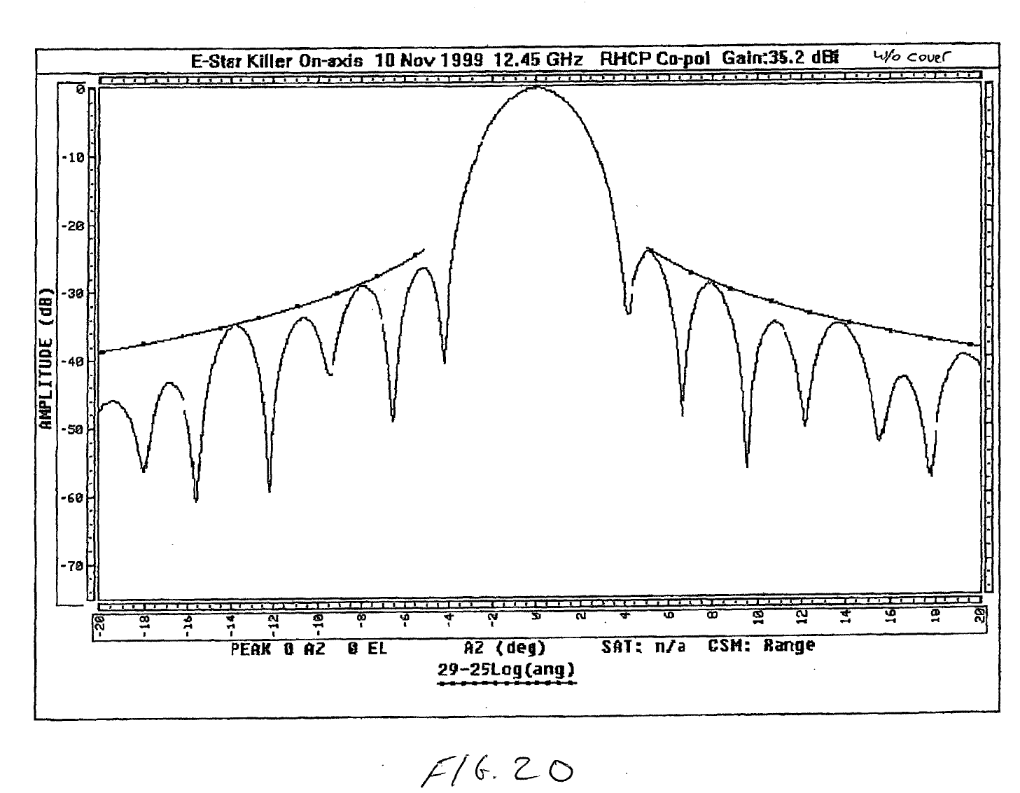

FIG. 18 is similar to FIGS. 16-17 as discussed above in comparing the two systems.

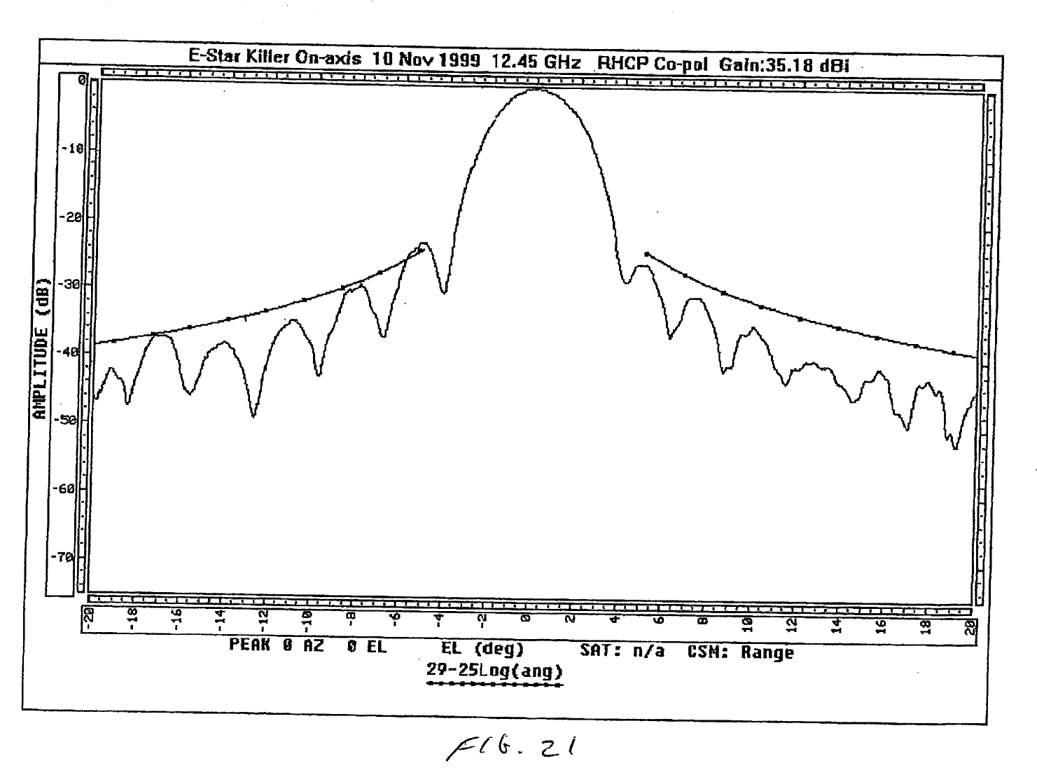

As for FIG. 19, it illustrates performance at 12.45 GHz of a multibeam offset parabolic antenna system of this invention having a FL of 15.0 inches, a D of 19 inches and a FL/D of 0.789. Curve 21 illustrates on-axis performance of the a multibeam offset parabolic antenna system of this invention having a FL of 15.0 inches, curve 22 illustrating its performance at +10 degrees off axis, and curve 23 illustrating its performance at −10 degrees off axis. As shown, curve 21 has a gain of about 35.2 dBi on-axis, while the antenna according to this invention has a gain −10 degrees off axis of about 34.8 dBi (see curve 23) and a gain +10 degrees off axis of about 34.8 dBi (see curve 22).

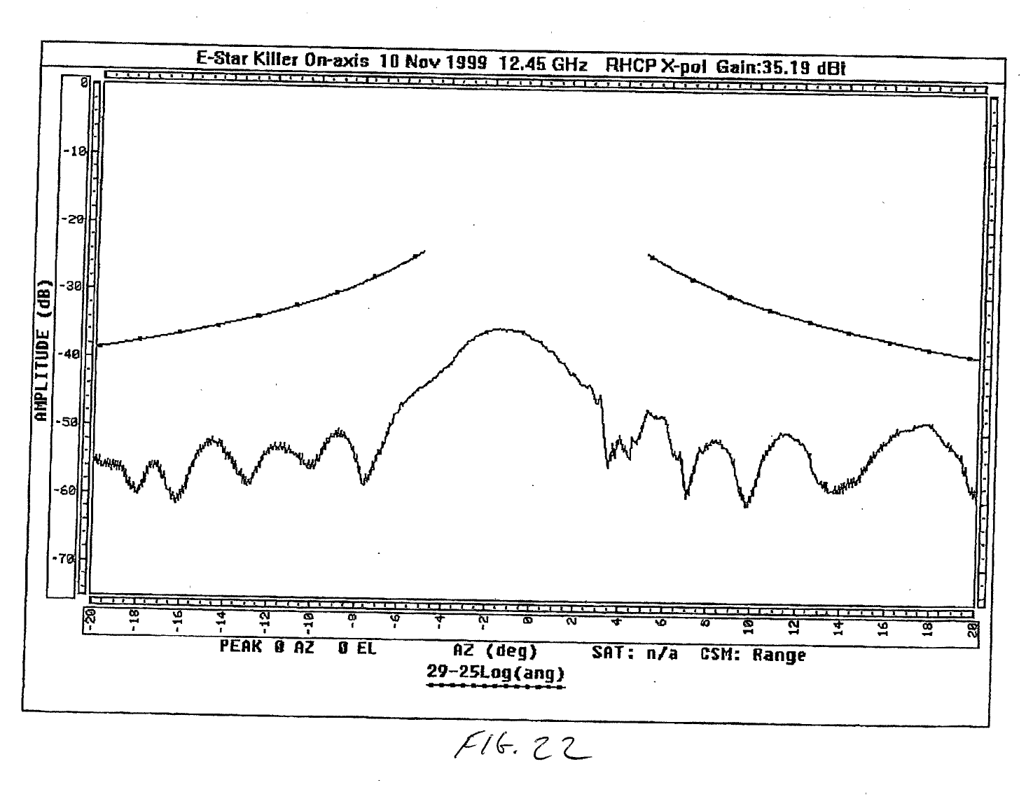

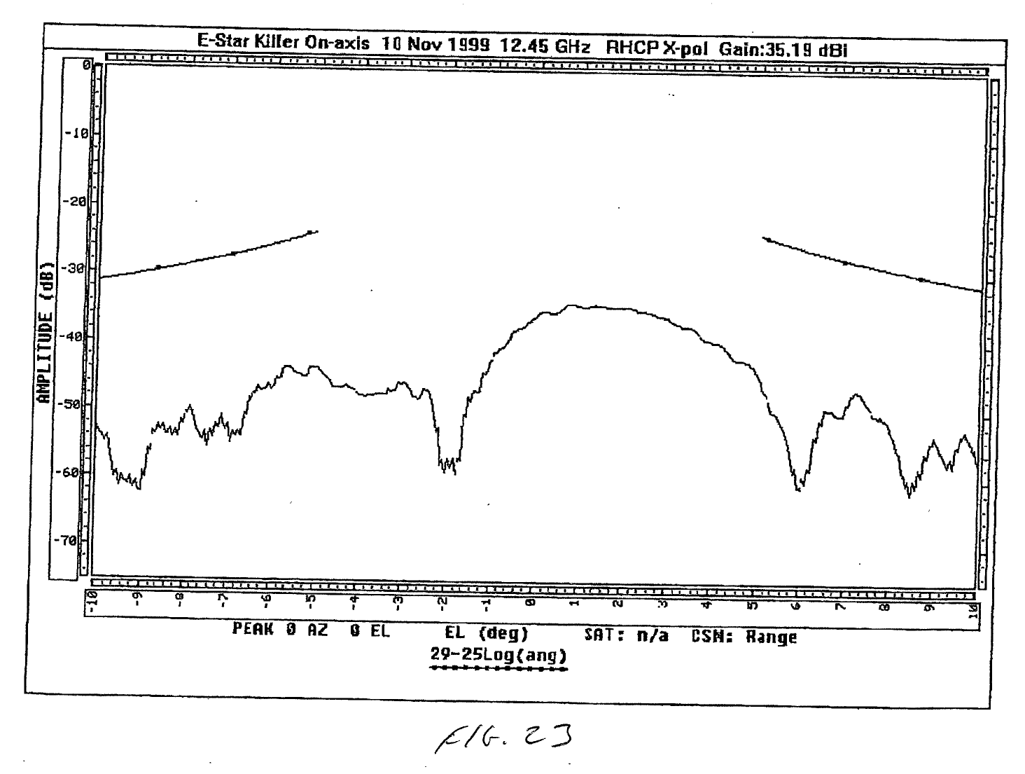

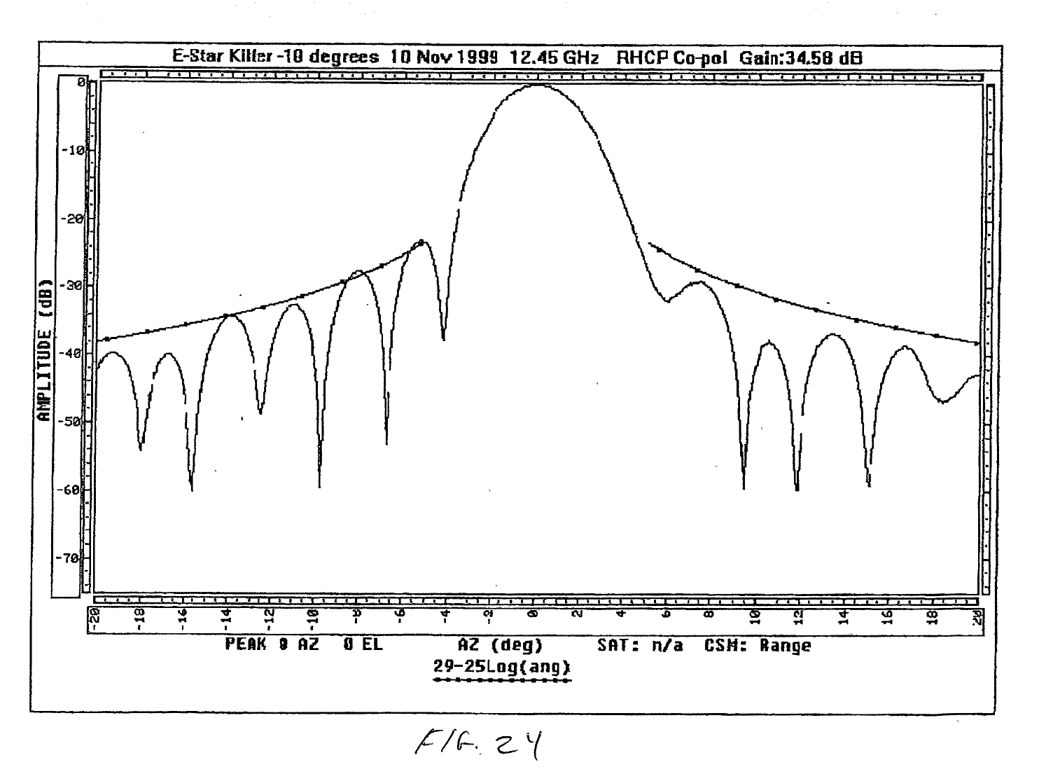

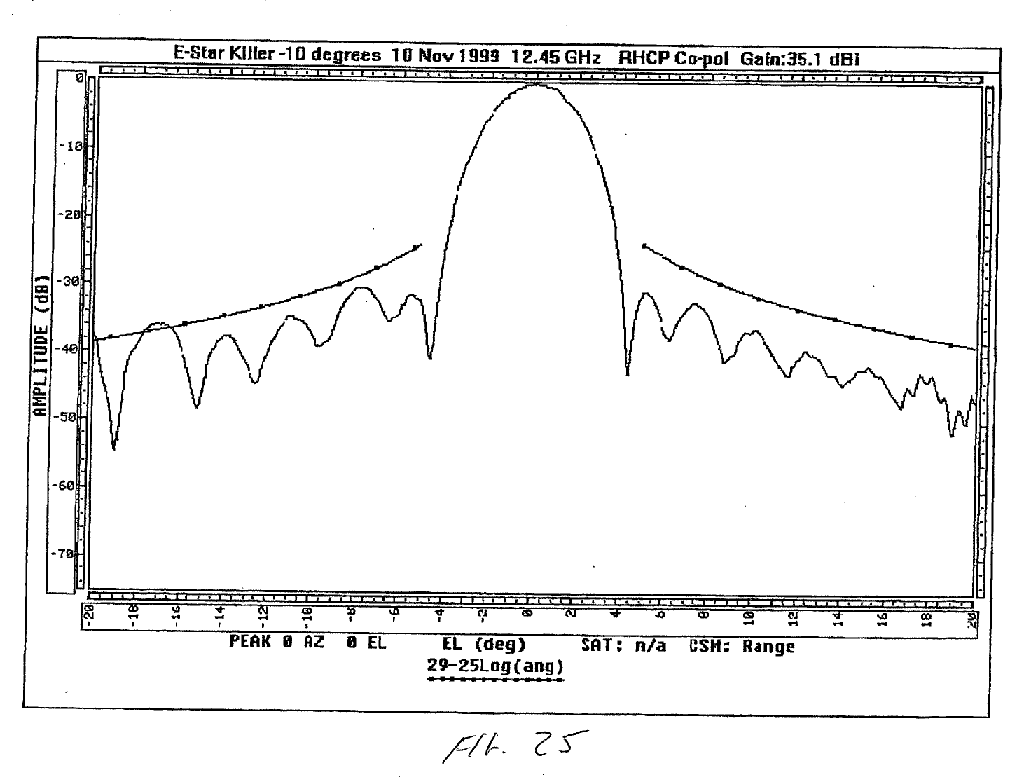

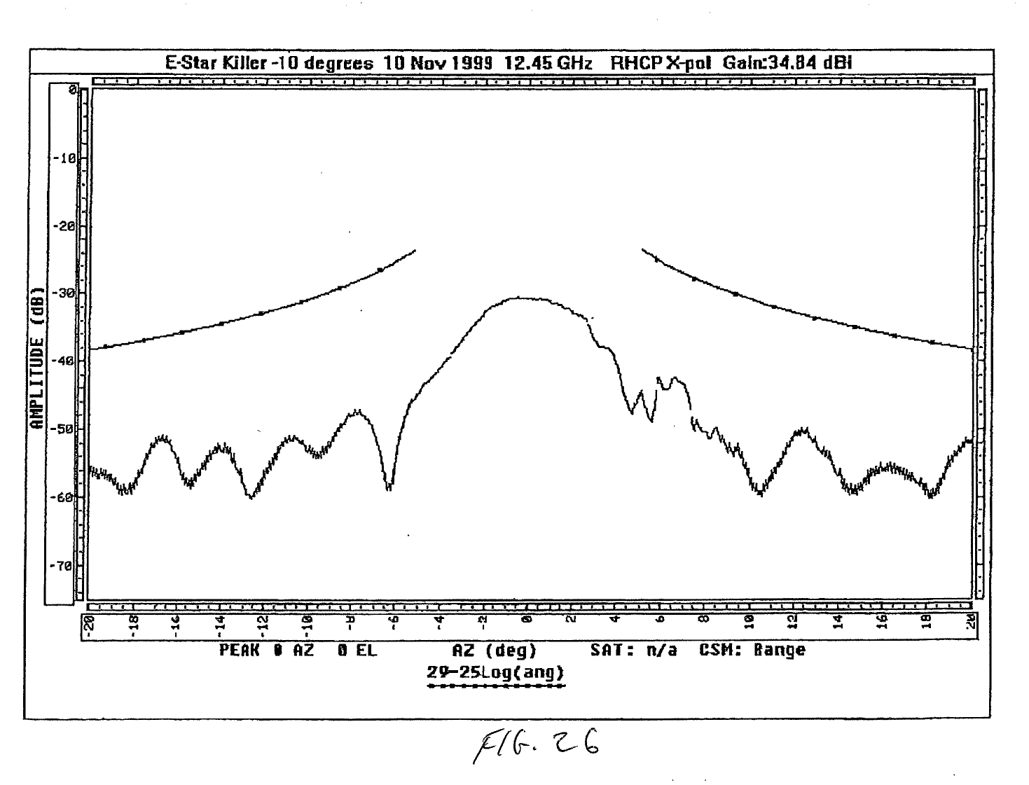

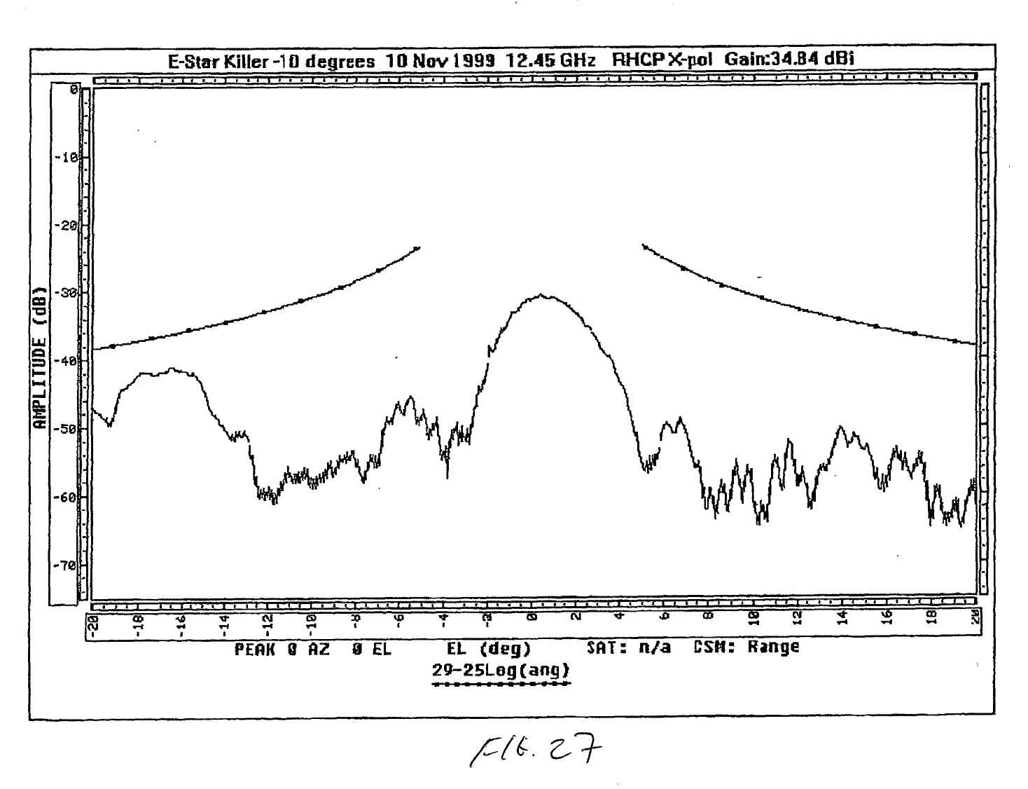

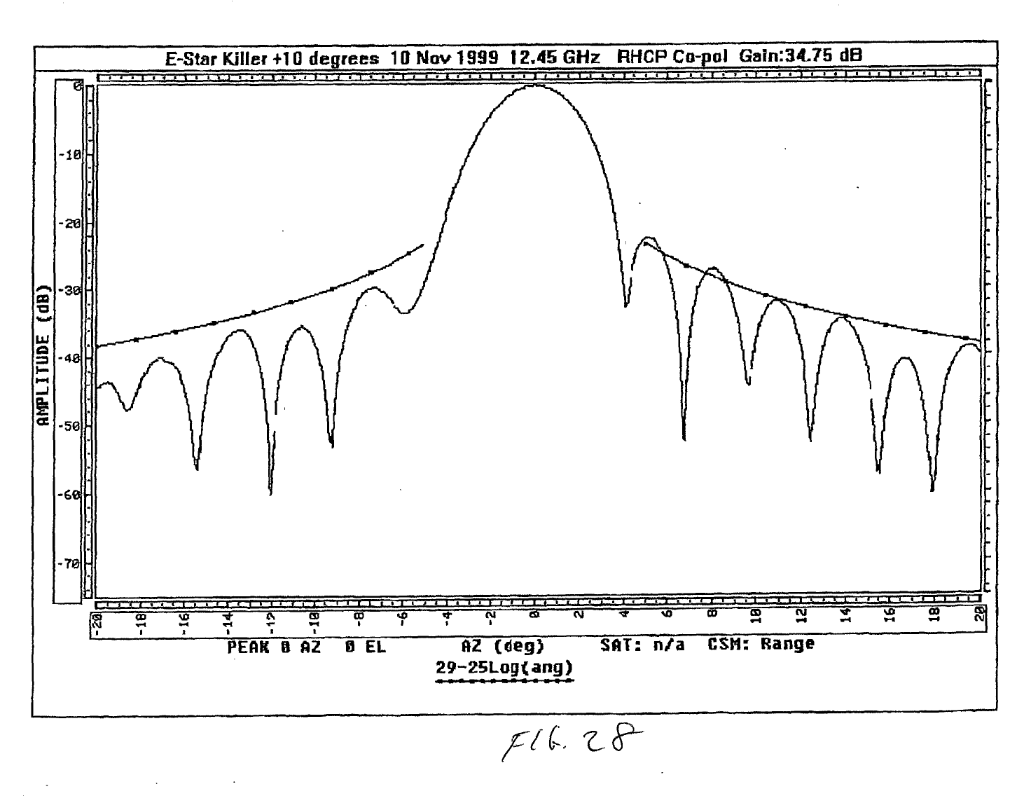

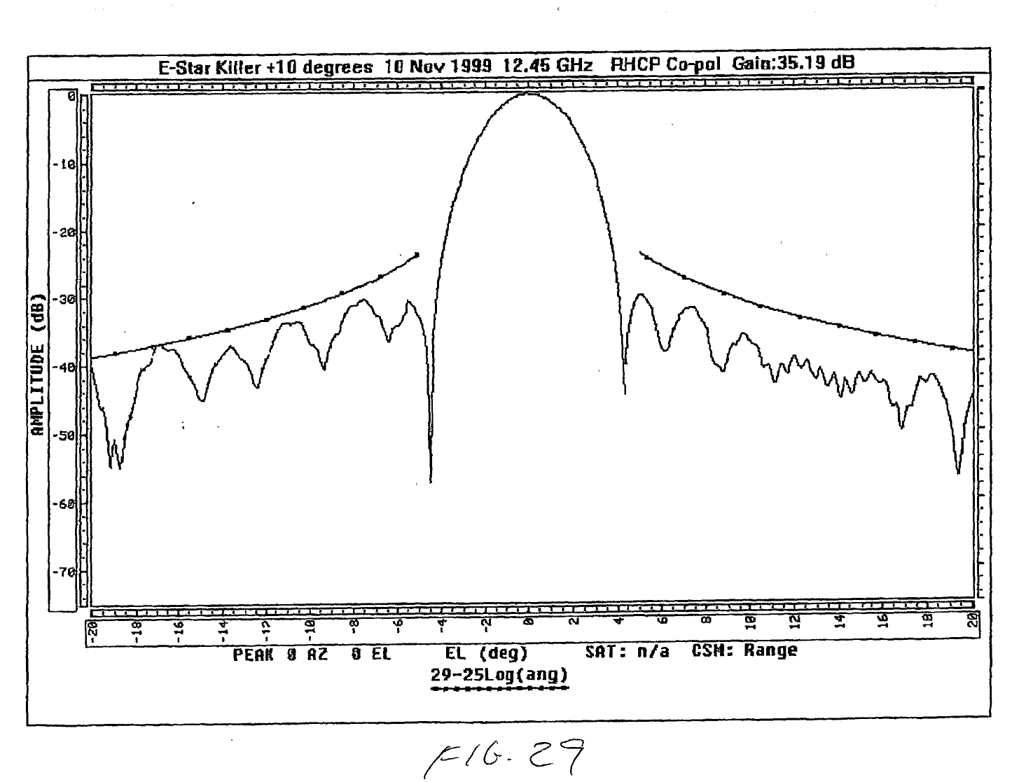

FIGS. 20-29 are graphs taken from an offset parabolic antenna system as shown in FIG. 2 having a 19 inch D and a FL of about 15.0 inches; these graphs having been taken from results obtained on the Comsat range in Gaithersburg, Md. These graphs illustrate the excellent on axis and off axis performance of the system according to this particular embodiment of this invention, and illustrate that when steered off axis the system maintains performance suitable for reception of DBS entertainment television signals from satellites.

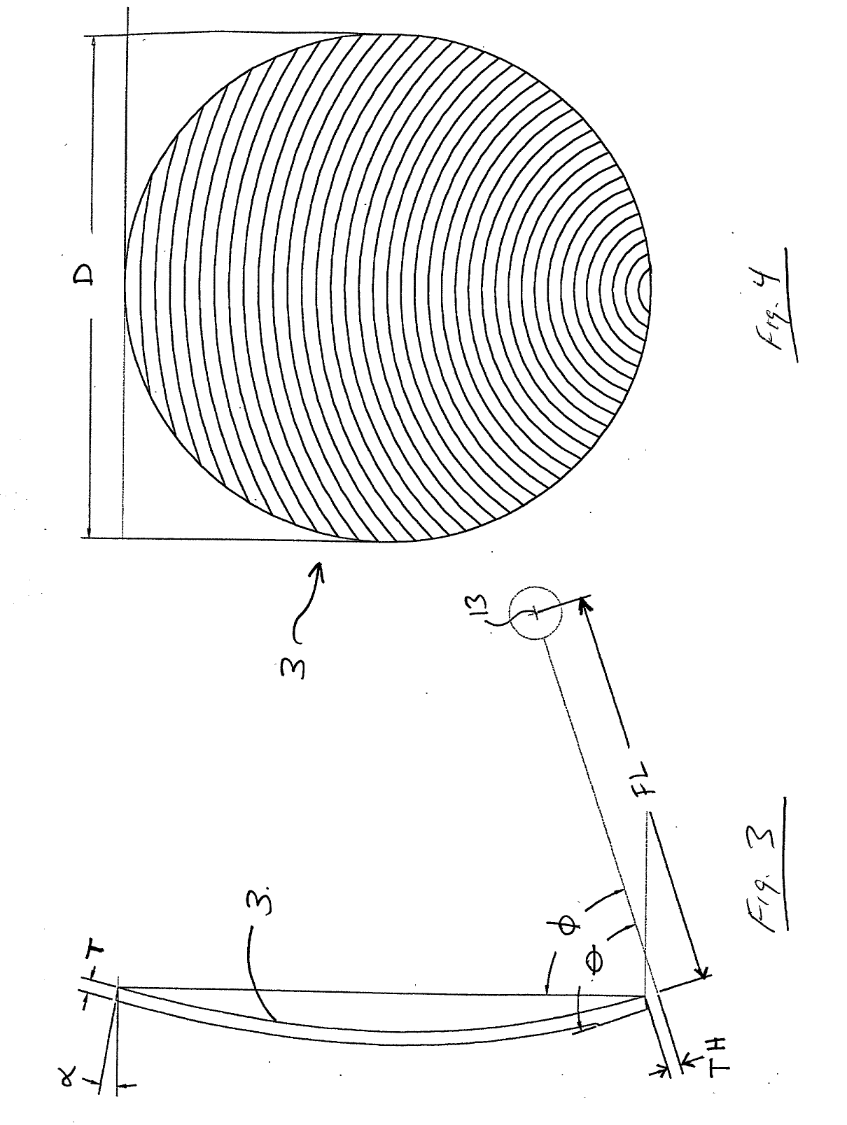

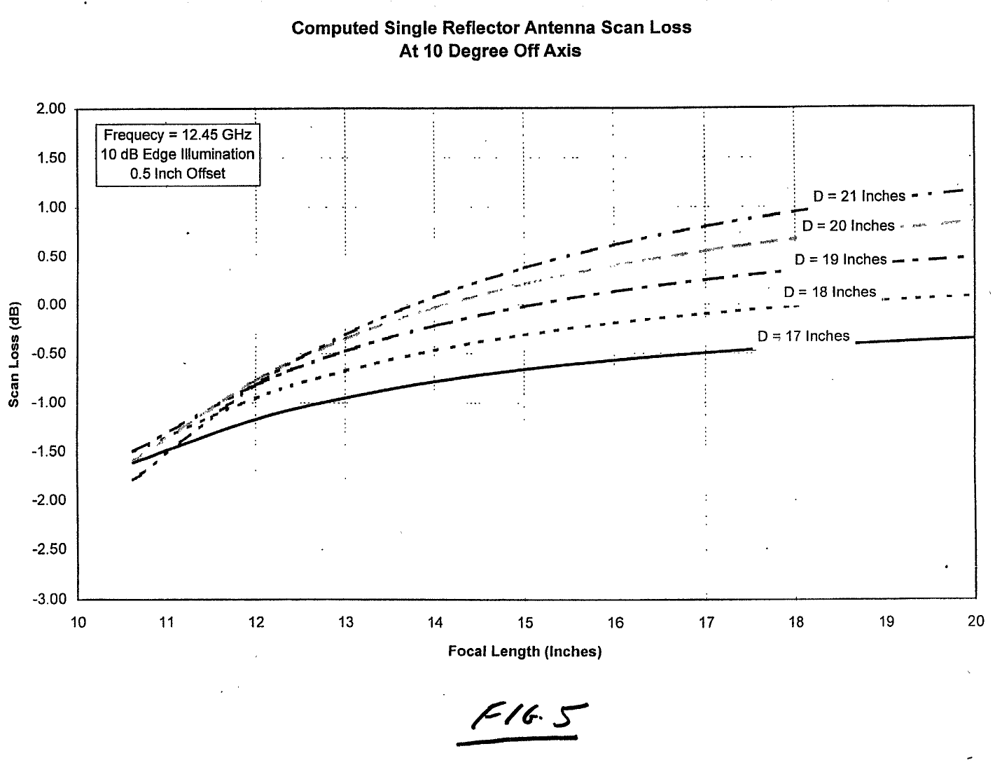

FIGS. 3-4 illustrate parabolic reflector 3 according to an exemplary embodiment of this invention. In this embodiment, FL is 15.0 inches, D is about 19 inches, T is about 0.5 inches, angle a is about 10 degrees, angle θ about 90 degrees, angle φ about 71-72 degrees, and TH about 0.5 inches.

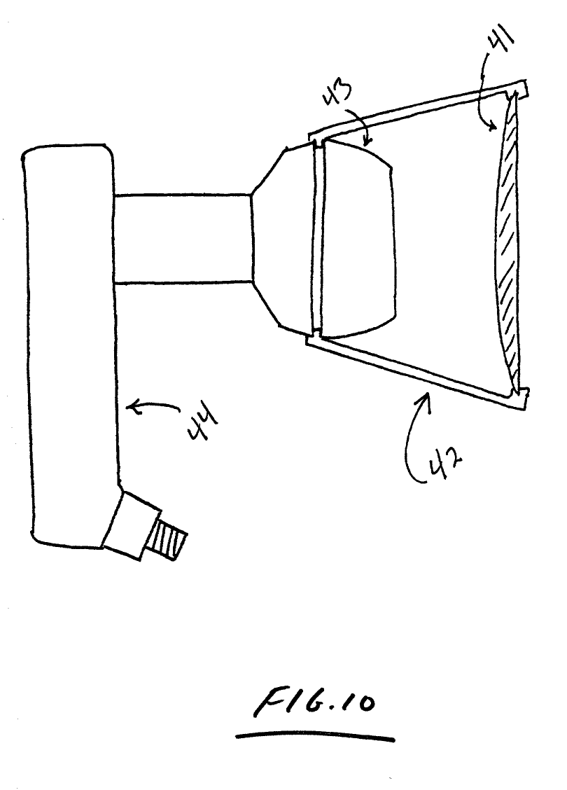

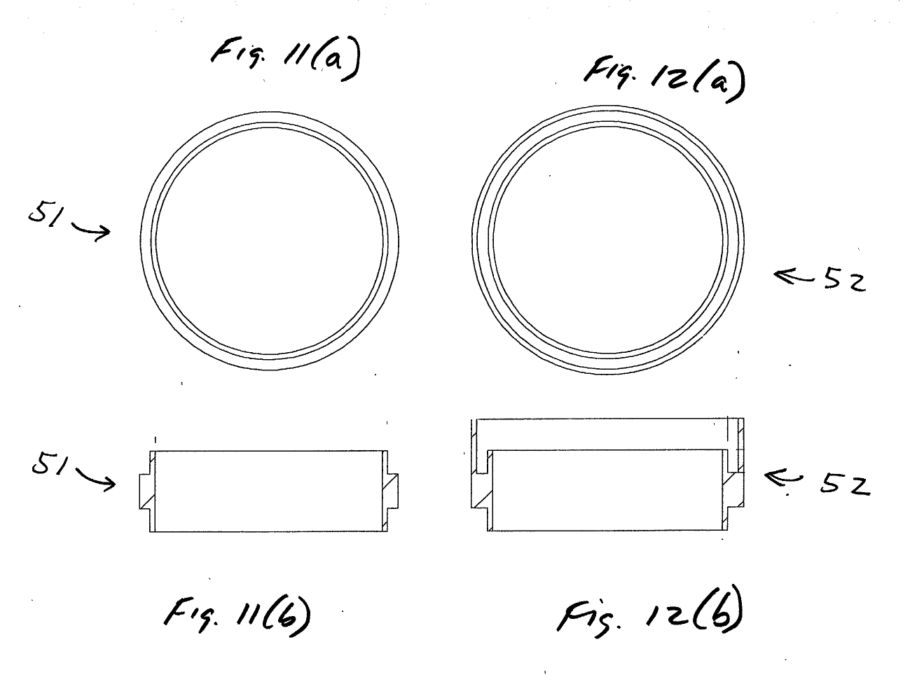

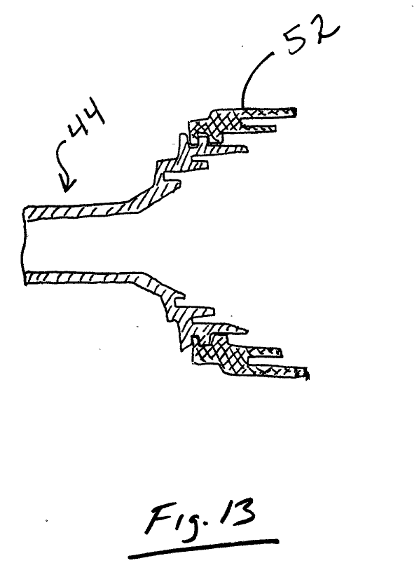

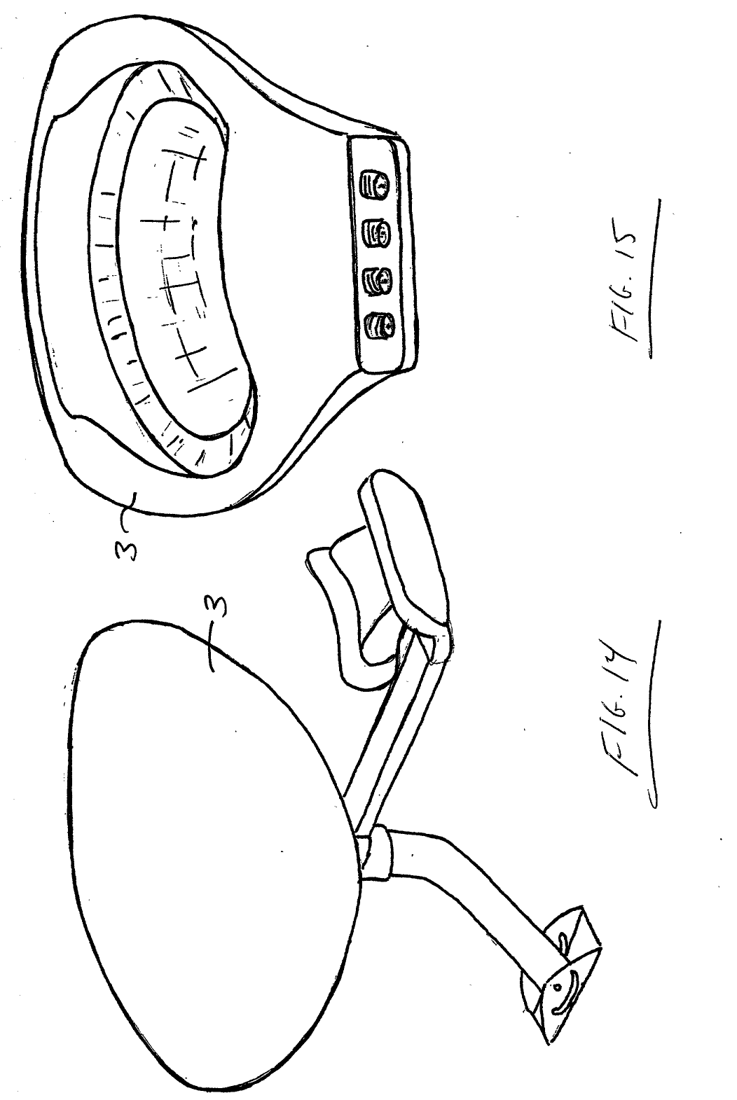

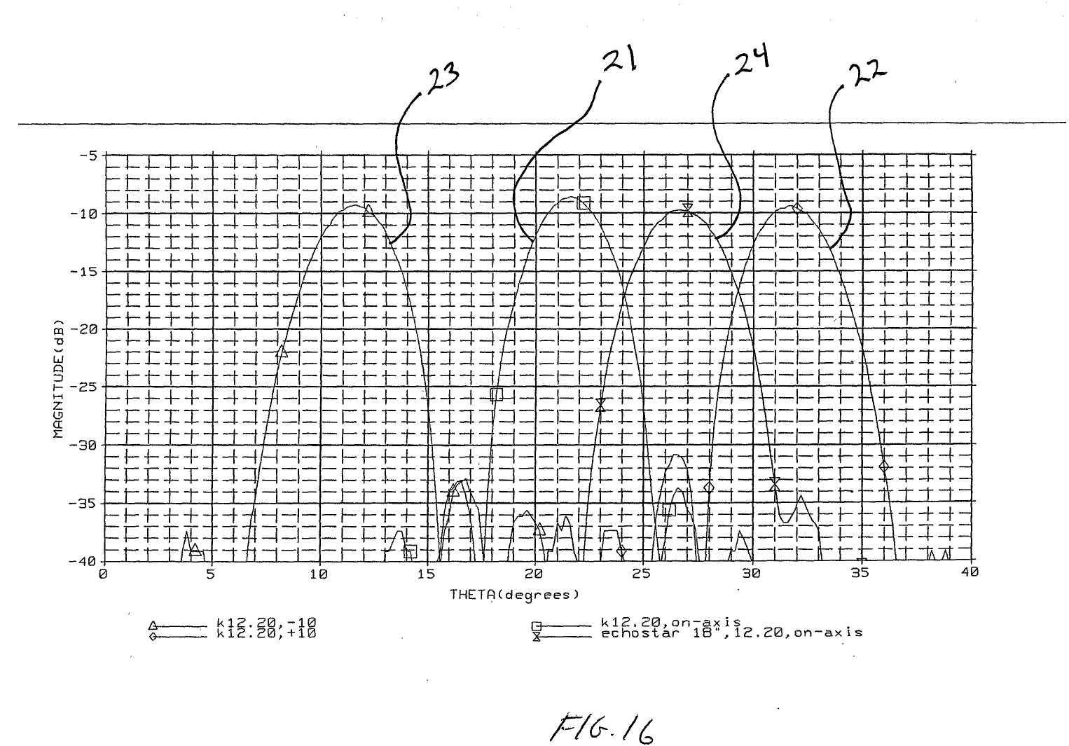

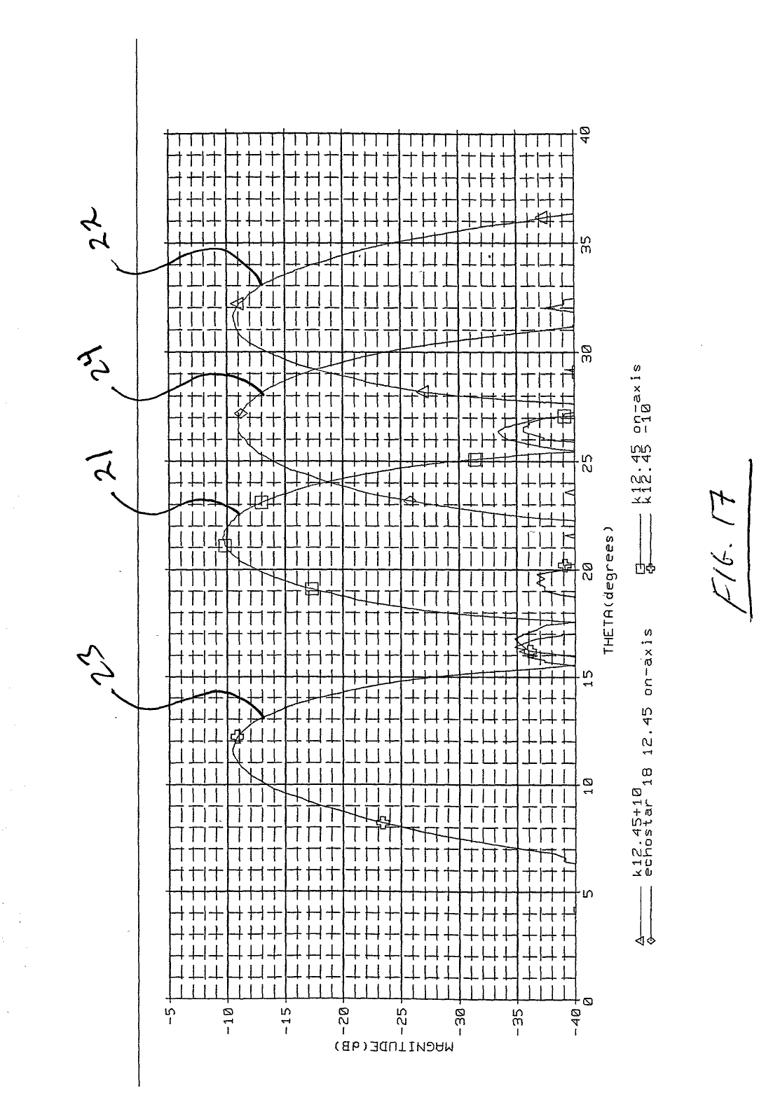

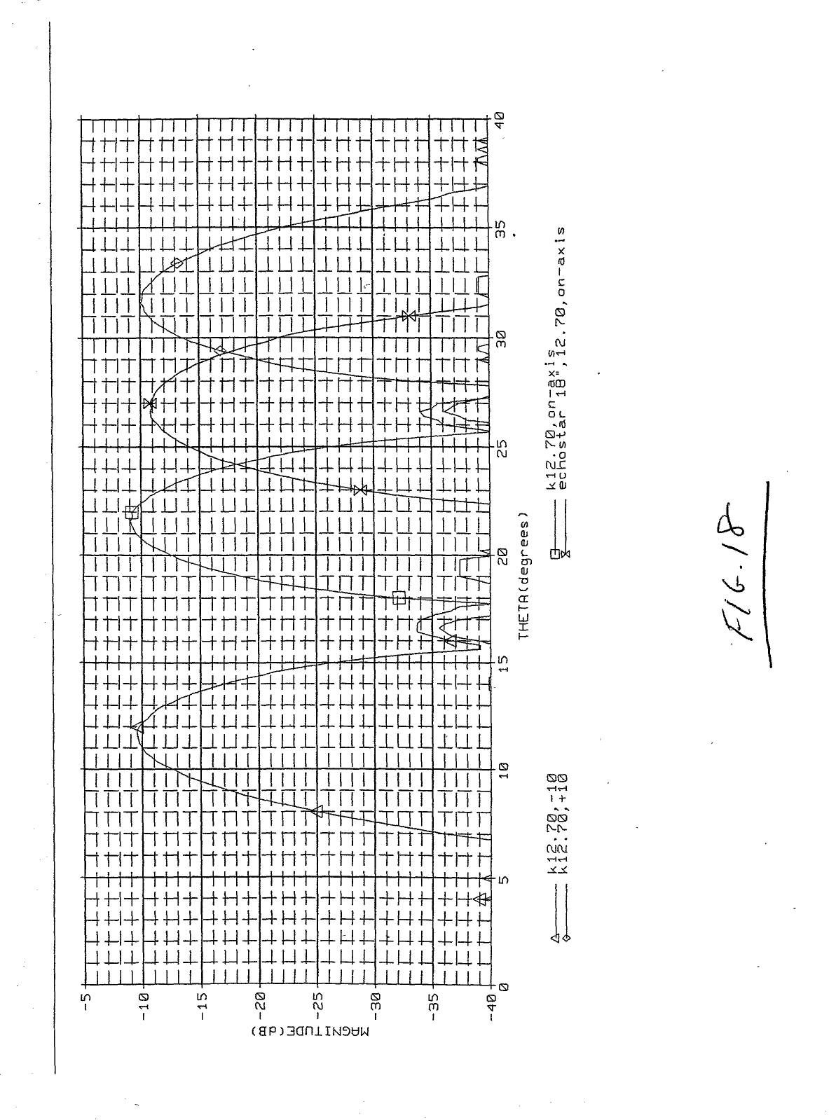

The offset parabolic reflector with FL and/or FL/D as described above may be used with a conventional DBS LNBF(s) in certain embodiments of this invention. However, in optional alternative embodiments, the feed horn design of a conventional DBS LNBF may be modified (e.g. either with a new feed design or a retrofit). On one embodiment exemplified by FIG. 10, a dielectric lens 41 is mounted via bracket 42 or radome 43 and conventional LNBF 44 for use with larger FL/D according to this invention. This added lens attached to the feed of the LNBF allows the LNBF(s) to be relocated to multiple “on” and “off-axis” positions while enabling the feed horn(s) to illuminate the longer FL/D reflector 3. Different shapes and/or sizes of lens 41 may be used to optimize performance for different satellite orbital spacing with different FL/D designs. Another optional embodiment is illustrated by FIGS. 11-13 where conventional LNBF(s) are retrofit with one or more additional choke rings (51 or 52) attachable to the perimeter of the LNBF feed horn(s). The added ring(s) enlarge the aperture of the feed horn that reduces the feed pattern to illuminate larger FL/D design of this invention. In still further embodiments, a non-retrofitting LNBF system may be provided at 11. An integrated multiple input (multi-satellite) LNBF utilizing common components may be more economical and/or compact than conventional discrete LNBFs; thereby enabling attachment of multiple feed horn systems to varying configurations of reflectors 3 for multiple satellite viewing. According to yet another embodiment, FIGS. 14-15 illustrate an exemplary embodiment of this invention with monoblock LNBF design, including multiple feeds.

Once given the above disclosure, therefore, various other modifications, features or improvements will become apparent to the skilled artisan. Such other features, modifications, and improvements are thus considered a part of this invention, the scope of which is to be determined by the following claims. For example, the above-discussed multiple beam antenna system can receive singularly or simultaneously any polarity (circular or linear) from a single or multiple number of satellites, from a single or multiple number of beams, knowing that co-located satellites utilize frequency and/or polarization diversity.

We claim:

1. A multiple beam antenna system for simultaneously receiving signals at different orbital spacing from different satellites, the system comprising:
an offset parabolic reflector having a focal length (FL) of at least about 14 inches; and
said parabolic reflector being dimensioned so as to have an FL/D of at least about 0.7, where D is a diameter of said reflector, so that said system has a gain loss of no more than about 1.5 dB relative to its on-axis gain when steered to off-axis viewing angles of from about +10 degrees to −10 degrees off axis.

2. The system of claim 1, wherein said FL/D is at least about 0.75 in order to improve off-axis performance of the system.

3. The system of claim 1, wherein said FL is at least about 15 inches and said D is less than about 20 inches.

4. The system of claim 1, further including multiple feedhorns and at least one lens attached to at least one of said feedhorns.

5. The system of claim 1, further including multiple LNBFs so that the system can simultaneously receive first, second, and third orbitally spaced signals from corresponding first, second, and third orbitally spaced satellites without experiencing a gain loss of more than about 1.5 dB.

6. The system of claim 1, wherein the system has a gain loss of no more than about 1.0 dB relative to its on-axis gain when steered to off-axis viewing angles of from about +10 degrees to −10 degrees off axis.

7. The antenna system of claim 1, wherein said antenna system is designed to receive satellite television signals from about 10.7-13 GHz, and wherein said system can simultaneously receive horizontally polarized signals and vertically polarized signals, and wherein said first signal is horizontally polarized and said second signal is vertically polarized.

8. The system of claim 1, further including means for simultaneously receiving both circularly polarized signals and linearly polarized signals and outputting said simultaneously received signals to a user.

9. The system of claim 1, further including means for simultaneously receiving multiple beams and multiple polarities of the circular and linear type.

10. A method of improving off-axis performance of an offset parabolic antenna system, comprising the steps of:
selecting a focal length (FL) and diameter (D) of a parabolic reflector so that FL/D is at least about 0.7 in order to improve off-axis performance; and
receiving a first satellite signal on axis and a second satellite signal at least about 8 degrees off axis in a manner such that the system experiences a gain loss of no more than about 1.5 dB when receiving the off axis signal relative to the on axis signal.

11. The method of claim 10, further comprising the step of receiving the first satellite signal on axis and the second satellite signal at least about 8 degrees off axis in a manner such that the system experiences a gain loss of no more than about 1.0 dB when receiving the off axis signal relative to the on axis signal.

12. The method of claim 11, further comprising the steps of selecting the FL to be at least about 14 inches and the FL/D to be at least about 0.75 in order to improve off-axis performance of the system.

13. The method of claim 10, further comprising the step of receiving the first satellite signal on axis and the second satellite signal at least about 8 degrees off axis in a manner such that the system experiences a gain loss of no more than about 0.75 dB when receiving the off axis signal relative to the on axis signal.

14. The method of claim 10, further comprising the step of receiving the first satellite signal on axis and the second satellite signal from about 8-10 degrees off axis in a manner such that the system experiences a gain loss of no more than about 0.5 dB when receiving the off axis signal relative to the on axis signal.

15. A multiple beam antenna system for simultaneously receiving signals at different orbital spacing from different satellites, the system comprising:
an offset parabolic reflector having a focal length (FL) and a diameter D dimensioned so as to have an FL/D of at least about 0.7 to improve off axis performance of the system; and
wherein the system has a gain loss of no more than about 1.0 dB relative to its on-axis gain when steered to an off-axis viewing angle of plus or minus 10 degrees.
